(19) United States
(12) Patent Application Publication
(10) Pub. No.: US 2006/0089851 A1
(43) Pub. Date: Apr. 27, 2006

(54) Informing consumers about carbon usage based on purchases

(76) Inventors: D. Wayne Silby, Washington, DC (US); Teresa M. Tennant, Borders (GB)

Correspondence Address: VENABLE LLP, P.O. BOX 34385, WASHINGTON, DC, 20045-9998, US

(21) Appl. No.: 11/255,997

(22) Filed: Oct. 24, 2005

Related U.S. Application Data
(60) Provisional application No. 60/621,092, filed on Oct. 25, 2004.

(51) Int. Cl. G06Q 99/00

(52) U.S. Cl. 705/1

(57) ABSTRACT

A method of processing financial data may include determining if a relationship exists between a particular item of said financial data and a quantifiable quality-related characteristic. It may further include generating data quantifying usage of the quality-related characteristic based on a particular item of financial data.

### CROSS-REFERENCE TO RELATED APPLICATION

This application claims the priority of U.S. Provisional Patent Application No. 60/621,092, filed on Oct. 25, 2004, and incorporated herein by reference.

### FIELD OF THE INVENTION

The present invention relates to methods and apparatus for using billing statements to provide consumers with their individual carbon usage in the matter of global warming, thereby allowing the opportunity for the consumer to take responsibility for their carbon emissions.

### BACKGROUND OF THE INVENTION

Climate change is recognized to be one of the most serious problems facing civilization and could fundamentally alter the planet as we know it within the next 100 to 200 years. The earth's climate has the potential to suffer irreversible destabilization. However, action now by citizens, governments and corporations can arrest the problem.

Scientific proof of climate change is most clearly found in the work of the Intergovernmental Panel on Climate Change (IPCC), who, in 2001, stated that global warming is linked to human behavior (since the start of the Industrial Revolution in 1750, there has been a 33% increase in atmospheric CO₂) and that surface temperatures will increase by between 1.4° C.-5.8° C. by 2100. Many experts, including the IPCC, consider that such a temperature change will have catastrophic impacts on the world's climatic and economic conditions. Further information on IPCC may be found at www.ipcc.ch/index.html.

More recently, in February 2004, U.S. Pentagon Advisers considered the implications for the U.S. of an Abrupt Climate Change Scenario and concluded that it should be a U.S. national security concern. Further information may be found at www.ems.org/climate/pentagon_climate_change.html. Government experts worldwide stress the need to reduce greenhouse gas emissions. The 2001 Kyoto Protocol provides a framework for inter-governmental action and is acting as a catalyst for regulatory initiatives including clean technology transfer between developed and emerging economies, and the creation of carbon markets. This is discussed, for example, at unfccc.int/resource/convkp.html.

On 3 Mar. 2004, the world's second-largest reinsurer, Swiss Re, warned that the costs of global warming threaten to spiral out of control, forcing the human race into a catastrophe of its own making. In a report revealing how climate change is rising on the corporate agenda, Swiss Re said the economic costs of global warming threatened to double to $150 billion a year in ten years, hitting insurers with $30-$40 billion in claims, or the equivalent of one World Trade Centre attack annually. See www.reuters.co.uk/newsPackageArticle jhtml?type=worldNews&storyID=468753&section=news.

A significant number of corporations are acting with regard to their emissions. For example Shell Oil has committed a billion dollars to renewable energy development, and Nike announced its intention to reduce emissions of CO₂ by 13% below 1998 levels by the end of 2005. See www.cdproject.net. However, the majority of corporations find it difficult to act ahead of consumer demand and government policy.

A major issue underlies the problem: the need to depoliticize responses to climate change and to influence public norms to be climate friendly. Market analysis suggests that people are willing to act. For example, Americans show a readiness to accept a moderate increase in their energy costs to deal with the problem of global warming and to comply with the Kyoto Treaty. Americans also show an optimism that reducing greenhouse gas emissions can be achieved without a harmful economic impact and that technological innovations will be effective. This is discussed, for example, at www.americans-world.org/digest/global_issues/global_warming/gw5.cfm.

In 1997, the first carbon accounting system was developed by the United Nations Environment Programme, described at www.unepfi.org/publications/climate_change/index.htm. Since then, several organizations have further refined the processes for carbon accounting, including the United Kingdom and Australian Governments, The World Resources Institute, and newer groups such as 500 PPM.

A number of facilities now exist to help consumers to reduce and pay for their carbon emissions. However, the systems currently available for carbon accounting may not be easily absorbable into an individual or family's regular payment processes. Examples of existing systems are those offered online by organizations such as Climate Care, discussed at www.co2.org/calculator/index.cfm, and Carbon Neutral, discussed at www.carbonneutral.com/calculators/index_shop_calculator.asp.

While there currently exists at least one credit card that in some way addresses carbon emissions, e.g., as described at www.greencardvisa.nl, such credit cards do not seem to associate carbon emissions with purchase data in a comprehensive and precise fashion.

In general, current services, generally involving proactive research by the buyer, do not offer the convenience of utilizing the credit card/billing systems, and this limits the scale and convenience of participation, as well as one's understanding of the association of carbon emissions with specific purchases.

The use of credit cards, such as affinity cards, for charitable purposes (where some amount of money depending upon total purchases goes to a charity) has been around for at least twenty years, when Working Assets introduced their card. Similarly, the use of frequent flyer miles as in-kind monetary rewards or coupons or “cash backs” has been well established. Most of the related U.S. patents, such as U.S. Pat. No. 6,631,358 (“Promoting savings by facilitating incremental commitments made with credit cards . . . ”) or U.S. Pat. No. 6,014,635 (“System and method for providing a discount credit transaction network”) are variations on this theme of total purchase “money type” benefits. There are other U.S. patents, for example, U.S. Pat. No. 6,672,507 (“Method and apparatus for printing a billing statement to provide supplementary product sales”) that ultimately result in some kind of “upsell” opportunity to the specific purchase with the purpose of enhancing sales. These systems are not about the qualitative theme of building awareness around individual purchases and providing the consumer an opportunity for altruism or a selfless act in support of an important global social issue.

U.S. Pat. No. 6,601,033 (“Pollution credit method using electronic networks”) does refer to an electronic network around pollution credits (specifically gas) where the credit is earned by the consumer as a result of an action they have taken, such as installing a home filtering device. The only mention of credit cards, however, is “to pay for the establishment of said Conditional Pollution Reduction Credit for said seller.”

### BRIEF SUMMARY OF THE INVENTION

Embodiments of the invention are directed to facilitating easy participation by the public using the point of bill/credit card payments to account for their carbon emissions impacts, thereby allowing them to take action to a level they choose to reduce their carbon footprint. A purpose of the invention is to engage the public in reducing carbon emissions as simply as possible using existing billing services. Various embodiments of the invention may take the form of methods, systems, and apparatus.

Part of the uniqueness of the invention is the “qualitative” aspects, in addition to some “quantitative” aspects in the use of a credit card. The invention is about a partnership with consumers in addressing the issue of global warming and their awareness, as individuals, of their participation in this issue through the use of their credit cards or bill presentments.

Our patent application is aligned with the goal of enabling citizens to act of their own accord to help ameliorate and reduce carbon emissions. This in turn will have positive knock on effects regarding corporate behavior and government policy.

### BRIEF DESCRIPTION OF THE DRAWINGS

Various embodiments of the invention will now be described in connection with the attached drawings, in which:

FIG. 1 shows an exemplary embodiment of a credit card statement according to embodiments of the invention;

FIG. 2 shows a flowchart of a method according to embodiments of the invention;

FIG. 3 shows a block diagram of a system according to embodiments of the invention; and

FIG. 4 shows a conceptual block diagram of a system that may be used to implement at least parts of some embodiments of the invention.

### DETAILED DESCRIPTION OF VARIOUS EMBODIMENTS OF THE INVENTION

Many consumers use credit cards or bill paying systems to pay for some or most of their purchases. The resulting bill presentment provides information on the vendor and the amount of the charge and is thus a convenient platform around which to deliver additional information around the carbon usage of each charge, especially those relevant to energy consumption. This provides an easy method for the consumer to become aware of and, if they so choose, to take responsibility for their energy usage. For example, users could choose, through a convenient means provided by the billing company, to purchase carbon offsets in order to become “carbon neutral.”

It is also not uncommon for credit card issuers to give premiums or credits for all items purchased on the billing statements. For example, many credit cards offer frequent flyer miles based on the amount of overall purchases as a premium for using the card. Others may offer some form of “cash back.” It is conceivable that some credit card issuers may wish to provide carbon offset credits, in lieu of, or in addition, to other such offerings thereby creating a type of partnership with the user in the account holders and issuer's mutual goal of reducing the carbon footprint resulting from the commercial transactions.

Additionally, embodiments of this invention may provide a convenient opportunity for vendors of various forms of products or services involving energy consumption to provide full, or partial, carbon credits to their customers through the billing issuer. For example, an airline may partner with a credit card issuer, where those account holders who choose, or are otherwise enrolled, in receiving their carbon usage information, may receive some form of credit by the airline, either unconditionally or requiring some kind of match by the account holder, on their statements. This may encourage vendors to compete and to differentiate themselves in such types of programs to partner with their consumers around the issue of global warming. Those users who show a “carbon neutral” impact on the earth from the information provided on their statements may be issued a credit card designed to declare their success toward the carbon neutral goal over a select period, or otherwise designed, or stamped, to show their participation in the awareness program.

Unlike other systems which use a billing statement to issue awards or cash backs or to try to make a commercial upsell to customers, embodiments of the present invention have as a purpose informing customers of the impact of their consumer activities around a major global issue with assistance from, and in some sense in partnership with, a billing provider. The system evokes a sense of altruism and personal responsibility in lieu of the offer of opportunity for personal gain.

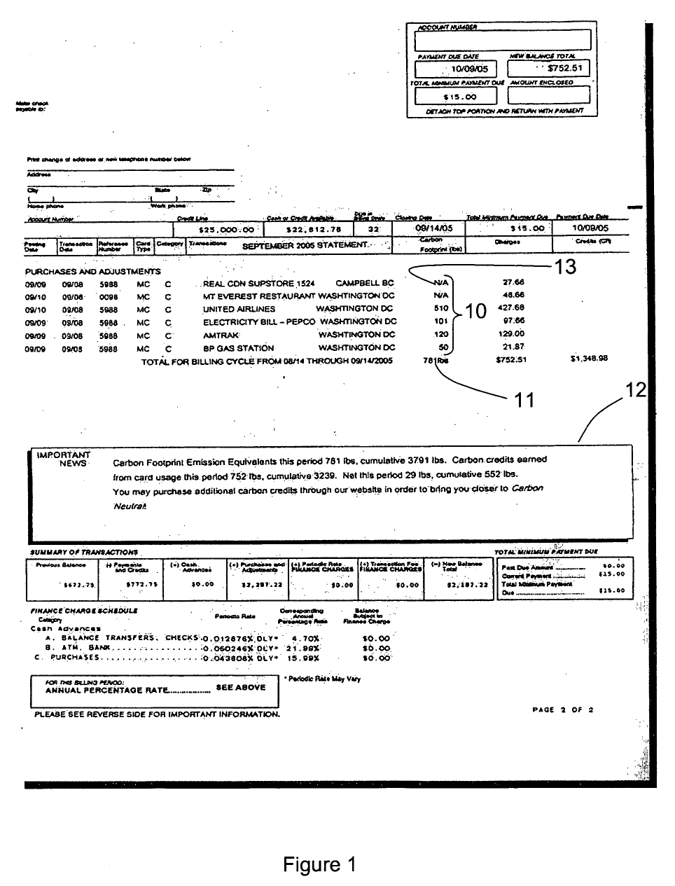

FIG. 1 shows an exemplary embodiment of a billing statement according to some embodiments of the invention. As shown, the billing statement includes estimates 10 of the carbon footprints related to various charges incurred by the consumer. Related to each charge will be an amount, e.g., in pounds, of estimated carbon production for those purchases where that purchase involved significant energy consumption (gasoline purchases, air travel, train travel, gas and electric bills, etc.). If the charge does not involve much energy consumption, some additional notation 13, for example, the letters “N/A,” may be used to denote that the particular charge is carbon neutral or negligible in its associated carbon emissions. The same or other notation may be used to denote a charge for which an estimate of the carbon production is not available. A total estimated carbon usage amount 11 may also be provided, which may use averaging data for some purchases and/or a total arising from known energy intensive purposes.

The billing statement may also grant carbon offset points (represented in an amount of carbon) based on the overall usage of the card. This allows the consumer to receive a benefit as a user of the card, which may also encourage more charges to be placed on the card as the user seeks to become carbon neutral. This furthers the partnership with the card issuer in addressing the issue of global warming. The consumer's carbon credits and carbon usage may be summarized as part of the billing statement, for example, but not necessarily, in a summary 12. This summary may provide information as to how the consumer may obtain further carbon credits to become carbon neutral. However, such information may be shown in other ways (i.e., not necessarily in the form of a summary box 12), and these other ways are also within the scope of the invention.

In order to provide the specific carbon usage information 10 shown in a statement, e.g., as in FIG. 1, general carbon usage information may be provided to the bill issuer, e.g., in the form of tables. Such general carbon usage information will provide relationships between the amount of carbon production and the amount of each charge. For bill issuers, for example, credit card companies, that may have multiple sources of charges, the general carbon usage information will need to include a database of those sources where carbon emission is a significant outcome in use of their products. (There are today more than 20 groups that do such calculations.) For example, if the charge says “Generic Airlines $300,” the system may, for example, using the general carbon usage information, identify the charge as one of significant carbon footprint production (e.g., by identifying the charge as being associated with information found among the general carbon usage information), and may further calculate, based on the general carbon usage information, the amount of carbon, e.g., on average, produced by a ticket costing $300. Many such calculations are made today and are generally available, or are otherwise able to be estimated based on industry averages. As an alternative, specific calculations may also be used, if available. Building on the Generic Airlines example, if Generic were to change their airplane fleet to more efficient aircraft, the emissions related to a dollar charge may be changed in the general carbon usage information to reflect less carbon usage per dollar charge. Furthermore, continuing with this example, flight-specific information may be used to create an even more precise amount of carbon emissions for that flight represented on the billing statement. This may also encourage energy consuming vendors to become more energy efficient as a feature in their marketing to consumers.

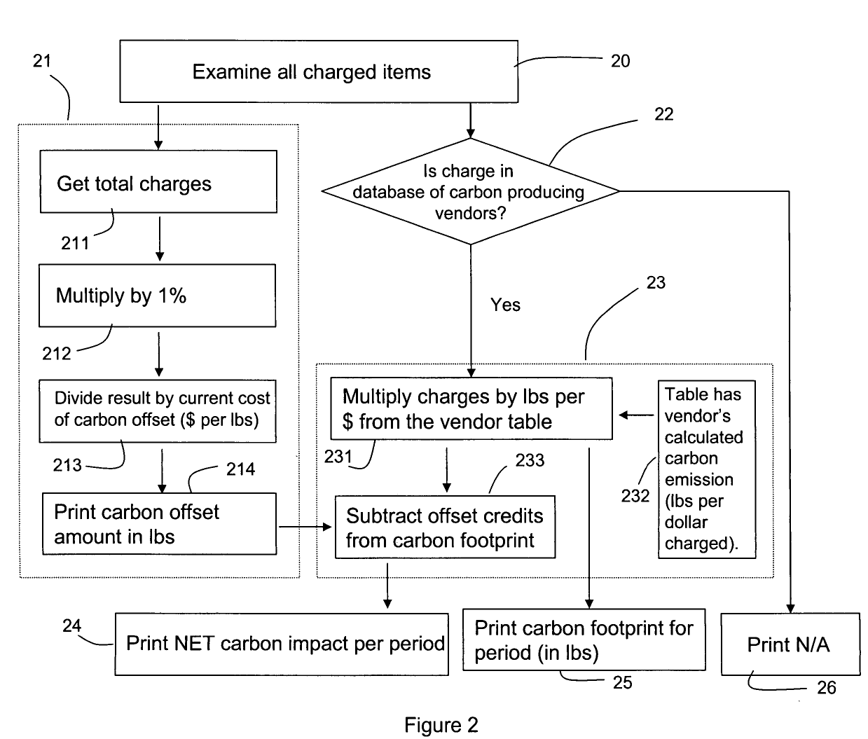

FIG. 2 shows an exemplary embodiment of a process by which the carbon usage calculations may be made and reported. There are two main parts of the process that occur based on an examination of all charges 20. The first is the calculation, if appropriate, of the carbon footprint (e.g., in pounds) created by the charge purchase 23, using the general carbon usage information, e.g., tables. The second is the calculation of all charges on the card and a carbon offset based on those charges 21. In the exemplary implementation shown in FIG. 2, it is presumed that 1% of the total purchases will go to offsetting the carbon footprint as a participant reward.

In the sub-process 21, total charges are determined 211. Then, in this example, 1% of that amount is calculated 212. This dollar amount is then translated into offsets purchased 213. The price of the offsets may vary depending on demand. The Chicago Board of Trade, for example, has a marketplace where such emission credits can be bought and sold, and the price fluctuates. The offsets thus purchased may, for example, be in the form of pounds. The resulting carbon offset amount may then be printed on a statement 214.

Charges are examined in block 22 to determine if there is carbon usage information available for those charges. If not, the process may print “N/A” or some other notation to let the consumer know that the carbon usage information for a particular charge (or vendor) is not available. Otherwise, the process may continue with sub-process 23.

In sub-process 23, the amount of a charge may be multiplied by general, per dollar, carbon usage information 231, which may be stored in a table 232. Alternatively, block 231 may merely retrieve the resulting carbon usage information for a particular charge if specific data (i.e., carbon usage per purchase, as opposed to carbon usage per dollar) is available. In yet another embodiment, block 231 may read carbon usage per unit item purchased and multiply it by the number of units purchased to determine the total carbon usage associated with the charge.

The resulting carbon usage associated with a particular charge may be printed 25. Furthermore, sub-process 23 may also total up the total carbon usage (associated with all charges on the statement) to thus obtain a carbon footprint for all the charges, which, again, may be printed 25. The carbon offset credits determined in sub-process 21 may then be subtracted from the carbon footprint 233 to determine a net carbon impact. This, too, may be printed on a statement 24.

Referring, again, to FIG. 1, the summary area 12 may also include cumulative information regarding the consumer's carbon usage footprint and/or offsets. Embodiments of the process shown in FIG. 2 may, therefore, also include the necessary blocks to compute these cumulative totals.

In some embodiments, the bill issuer may also allow the consumer to purchase additional offsets towards the consumer's goal of becoming “carbon neutral.” In some embodiments, e.g., in the case where the bill issuer is a credit card company or other credit source, the vendors may also elect to give credits in participation with their customers, which may also be reported on the statements and may be considered along with the consumer's own charges (e.g., in being subtracted from the consumer's carbon usage). In further embodiments, one may “trade in” Frequent Flyer miles, or other such premiums, for carbon offset credits and have those be considered. In yet another embodiment, general merchandisers may give carbon offset coupons as a premium for cash purchases, which may be submitted to a bill issuer to be counted as part of the consumer's carbon offsets.

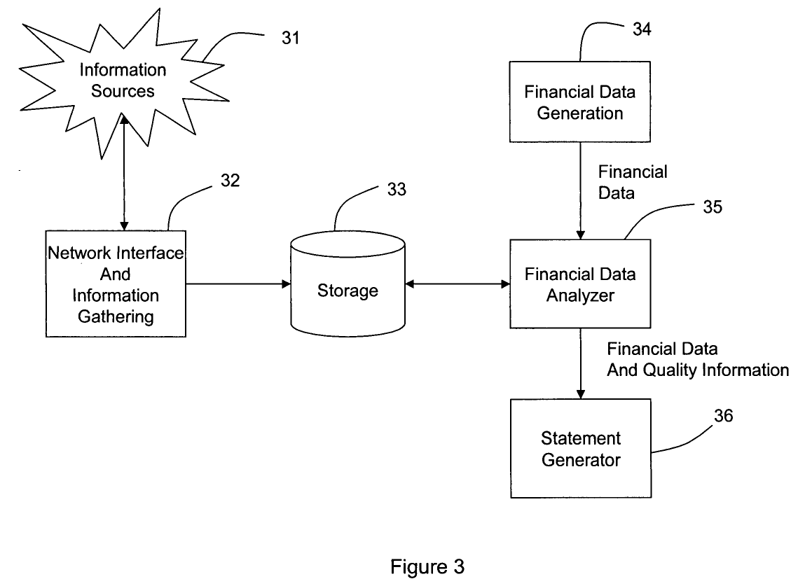

FIG. 3 shows a block diagram of a system for analyzing and associating carbon emissions data with financial data, according to an embodiment of the invention. In FIG. 3, a financial data analysis engine 35 obtains financial data from a financial data generating engine 34. Such a financial data generating engine 34 may generate financial data in the form of credit card purchases, bank account debits and/or checks, utility bills, etc., according to how they were used (i.e., the recipient of the payment). The financial data analysis engine 35 may obtain information on how purchases correlate with carbon emissions and may correlate this data with the financial data received from the financial data generating engine 34. As a result, the financial data analysis engine 35 may generate carbon emissions data corresponding to each item of financial data. Finally, the financial data and the carbon emissions data may be fed to a statement generator 36 for preparing a statement for the consumer.

As discussed above, the financial data analysis engine 35 obtains information on how purchases correlate with carbon emissions. This may be done, for example, by accessing a storage medium 33 containing such information. Such a storage medium may be, for example, a hard disk, a CD-ROM, a floppy disk, or any other known or as yet to be developed memory device.

The system may further include at least one network interface and/or other means for gathering information on how purchases correlate with carbon emissions 32. This may include interfaces with one or more communication networks, which may include the Internet, a telephone network, hard-wired connections, wireless networks, and/or any other known or as yet to be developed communication network. This may also include means by which a user may manually enter data and/or by which a machine-accessible medium may be accessed (a machine-accessible medium may be, for example, a memory device, an electromagnetic or optical signal, etc.).

Information on how purchases correlate with carbon emissions may be obtained from numerous types of sources 31, some of which are discussed above. Such sources 31 may include, for example, government sources, universities, private organizations, and/or commercial databases.

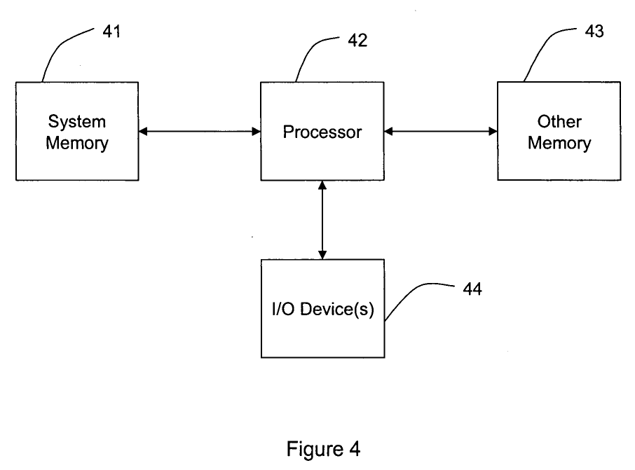

Some embodiments of the invention, as discussed above, may be embodied, at least in part, in the form of software instructions on a machine-accessible medium. Such an embodiment may be illustrated in FIG. 4. The computer system of FIG. 4 may include at least one processor 42, with associated system memory 41, which may store, for example, operating system software and the like. The system may further include other additional memory 43, which may, for example, include software instructions to perform various applications. System memory 41 and other memory 43 may comprise separate memory devices, a single shared memory device, or a combination of separate and shared memory devices. The system may also include one or more input/output (I/O) devices 44, for example (but not limited to), keyboard, mouse, trackball, printer, display, network connection, etc. The present invention, or parts thereof, may be embodied as software instructions that may be stored in system memory 41 or in other memory 43. Such software instructions may also be stored in removable or remote media (for example, but not limited to, compact disks, floppy disks, etc.), which may be read through an I/O device 44 (for example, but not limited to, a floppy disk drive). Furthermore, the software instructions may also be transmitted to the computer system via an I/O device 44, for example, a network connection; in such a case, a signal containing the software instructions may be considered to be a machine-accessible medium. The system of FIG. 4 may be coupled to various hardware components shown in FIG. 3.

It is further noted that the invention need not be limited to carbon emissions. Other types of quantifiable quality-related characteristics may also be associated with purchases. “Quantifiable quality-related characteristics” is meant, for the purposes of this discussion, to describe things relating to quality of human life and/or the environment. This is in contrast to tangible financial rewards, merchandise credits, or the like. For example, sulfur dioxide emissions, rainforest destruction, and water pollution are further environment-related quantities that may be associated with various purchases. Poor labor conditions (e.g., below-poverty-level wages or child labor) may be viewed as a non-environmental type of characteristic falling into this category. As with carbon emissions, a similar system of credits may be used with each; the main thing is that purchases be associated with usage, and credits go toward addressing the condition caused by the usage (e.g., by becoming carbon neutral, by purchasing rainforest land, by contributing to an organization that addresses child or slave labor issues, etc.). Furthermore, embodiments of the invention may include more than one type of such quantifiable quality-related characteristics associated with purchases.

The invention is described in detail with respect to various embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. A method of processing financial data, comprising:
determining if a relationship exists between a particular item of said financial data and a quantifiable quality-related characteristic; and
generating data quantifying usage of said quality-related characteristic based on a particular item of said financial data.

2. The method according to claim 1, wherein said quantifiable quality-related characteristic is selected from the group consisting of: carbon emissions, water pollution, sulfur dioxide emission, and rainforest destruction.

3. The method according to claim 1, wherein said financial data comprises purchase information.

4. The method according to claim 1, wherein said financial data comprises at least one credit card billing item.

5. The method according to claim 1, wherein said determining comprises:
determining if there is data available to relate a financial quantity to a quantity of said quantifiable quality-related characteristic.

6. The method according to claim 1, wherein said generating comprises:
multiplying an amount associated with said financial data by a factor associated with said quantifiable quality-related characteristic.

7. The method according to claim 6, wherein said factor comprises a per unit amount spent amount of said quality-related characteristic.

8. The method according to claim 1, further comprising:
generating a financial statement.

9. The method according to claim 9, wherein said financial statement includes at least a portion of said financial data and at least a portion of said data quantifying usage.

10. The method according to claim 1, further comprising:
computing an offset amount based on at least some portion of said financial data.

11. The method according to claim 10, wherein said computing comprises multiplying a total amount of said financial data by a percentage to determine said offset amount.

12. The method according to claim 10, further comprising:
comparing said data quantifying usage with said offset amount to determine a net usage.

13. The method according to claim 12, further comprising:
offering the purchase of offset credits to reduce said net usage.

14. A machine-accessible medium containing instructions that, when executed on a processor, cause said processor to perform the method according to claim 1.

15. A method of associating carbon emissions information with credit card use information, comprising:
gathering said credit card use information;
analyzing said credit card use information for association with said carbon emissions information, comprising:
inputting information about correlation between said credit card use information and said carbon emissions information; and
applying said information about correlation to said credit card use information to generate corresponding carbon emissions information; and
outputting said credit card use information and said carbon emissions information.

16. The method according to claim 15, further comprising:
gathering information about correlation between said credit card use information and said carbon emissions information.

17. The method according to claim 16, wherein said gathering information includes obtaining information from at least one source selected from the group consisting of: a government agency, a private organization, and a university.

18. The method according to claim 16, wherein said gathering information includes downloading information from a computer on a computer network.

19. The method according to claim 16, wherein said gathering information includes reading information from a machine-accessible medium coupled to a computer system.

20. The method according to claim 16, wherein said gathering information includes manually inputting said information.

21. The method according to claim 16, wherein said information about correlation between said credit card use information and said carbon emissions information comprises information correlating purchases with carbon emissions.

22. The method according to claim 15, further comprising:
permitting a consumer to purchase carbon emissions credits.

23. An apparatus for analyzing financial data, comprising:
a financial data analysis engine to receive financial data, the financial data analysis engine to analyze said financial data; to correlate said financial data with carbon emissions information relating to said financial data; and to generate carbon emissions data corresponding to said financial data; and
a statement generating engine coupled to receive said financial data and said carbon emissions data and to generate at least one financial statement including both said financial data and said carbon emissions data.

24. The apparatus according to claim 22, further comprising:
a storage medium to store said carbon emissions information, the storage medium to provide said carbon emissions information to said financial data analysis engine.

25. The apparatus according to claim 22, further comprising:
an information gathering engine to gather said carbon emissions information and to provide said carbon emissions information to said financial data analysis engine.

26. The apparatus according to claim 22, wherein said information gathering engine comprises a network interface.

27. The apparatus according to claim 22, wherein said information gathering engine comprises a user input device.

28. The apparatus according to claim 25, wherein said information gathering engine comprises a device to read a machine-accessible medium containing said carbon emissions information.

29. The apparatus according to claim 25, wherein said information gathering engine gathers said carbon emissions information from at least one of the group consisting of: a government agency, a private organization, and a university.

30. A financial data analysis system comprising:
a financial data generating engine to provide financial data; and
the apparatus according to claim 25 coupled to receive said financial data from the financial data generating engine.

31. The financial data analysis system according to claim 30, wherein the financial data generating engine is coupled to said financial data analysis engine by at least one of the group consisting of: a hard-wired connection; a communication network; a common storage medium; and a wireless connection.

32. The financial data analysis system according to claim 25, wherein said financial data generating engine and said financial data analysis engine are embodied in a single computer system.

33. The apparatus according to claim 25, wherein said carbon emissions information comprises information correlating purchases with carbon emissions.
